(19) United States
(12) Patent Application Publication
(10) Pub. No.: US 2008/0028734 A1
(43) Pub. Date: Feb. 7, 2008

(54) Filter assembly

(76) Inventor: Michael S. McClain, Ortonville, MI (US)

Correspondence Address: DELPHI TECHNOLOGIES, INC., M/C 480-410-202, PO BOX 5052, TROY, MI, 48007, US

(21) Appl. No.: 11/498,622

(22) Filed: Aug. 3, 2006

(51) Int. Cl. B01D 46/00

(52) U.S. Cl. 55/495; 55/505; 55/410; 210/459

(57) ABSTRACT

A filter assembly having a filter media and adapted for use with a tube includes a filter housing adapted to contain the filter media therein. The filter housing includes a first nipple and a second nipple, at least one of which is adapted to engage with the tube. At least one engaging member is adapted to releasably engage with a corresponding engaging member of a manifold via a rotation of the filter housing from about 1° to about 180°.

### BACKGROUND

The present disclosure relates generally to a filter assembly.

A cannula filter may be utilized with oxygen delivery systems where oxygen is supplied via a cannula port. Such a filter may act as a HEPA and/or bacterial filter for an oxygen delivery system.

Cannula filters are typically mounted via a standard dual barbed system suspended between lines, or are threadingly engaged via threaded ports. It is generally necessary to keep multiple filter configurations in inventory in order to accommodate various inlet tube sizes and port arrangements.

Many stationary oxygen concentrators, and other devices for delivering gases to patients, include an access door or attaching hardware. Such doors and hardware generally require removal in order to replace the filter, thereby potentially increasing the complexity of filter changing processes.

As such, it would be desirable to provide a method and apparatus for mounting an easily installable, multi-purpose filter.

### SUMMARY

A filter assembly having a filter media and adapted for use with a tube is disclosed. The filter assembly includes a filter housing adapted to contain the filter media therein. The filter housing also includes a first nipple and a second nipple, at least one of which is adapted to engage with the tube. At least one engaging member is adapted to releasably engage with an engaging member of a manifold via a rotation of the filter housing from about 1° to about 180°.

### BRIEF DESCRIPTION OF THE DRAWINGS

Objects, features and advantages of embodiments of the present disclosure will become apparent by reference to the following detailed description and drawings, in which like reference numerals correspond to similar, though not necessarily identical components. Reference numerals having a previously described function may not necessarily be described in connection with other drawings in which they appear.

FIG. 1 is an exploded side perspective view of an embodiment of a filter assembly;

FIG. 2 is a side perspective view of an embodiment of the filter assembly;

FIG. 3 is a front perspective view of an embodiment of a filter assembly aligned for engagement with a manifold;

FIG. 4 is a cutaway front perspective view of an embodiment of a filter assembly engaged with a manifold; and

FIG. 5 is a cross-sectional view of an embodiment of a filter assembly engaged with a manifold.

### DETAILED DESCRIPTION

Embodiments of the filter assembly disclosed herein may advantageously engage two tubes having different diameters or connections. In other embodiments of the filter assembly, one tube may be engaged with one portion of the filter assembly, while another portion of the filter assembly may be quickly and easily engaged with a manifold via o-rings, gaskets, or face seals. It is believed that this type of engagement substantially simplifies the interface between the filter assembly and the manifold, thereby substantially simplifying the process for replacing the filter.

The filter assembly disclosed herein also may advantageously be utilized with devices for delivering gases to patients, which devices would not require (though optionally may have, if desired) access door(s) and/or attaching hardware for replacing the filter assembly. As such, the filter assembly may be suitable for use in stationary and/or portable oxygen concentrators and other gaseous delivery devices.

As used herein, the term “tube” includes source tubes, cannulas, pipes, other like tubular objects, or combinations thereof for delivery of a gaseous medium/media.

It is to be understood that the terms “engage/engaged/engagement/engageable” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “engaged with” the other component is somehow in operative communication with the other component (notwithstanding the presence of one or more additional components therebetween). Additionally, two components may be permanently, semi-permanently, or releasably engaged with one another.

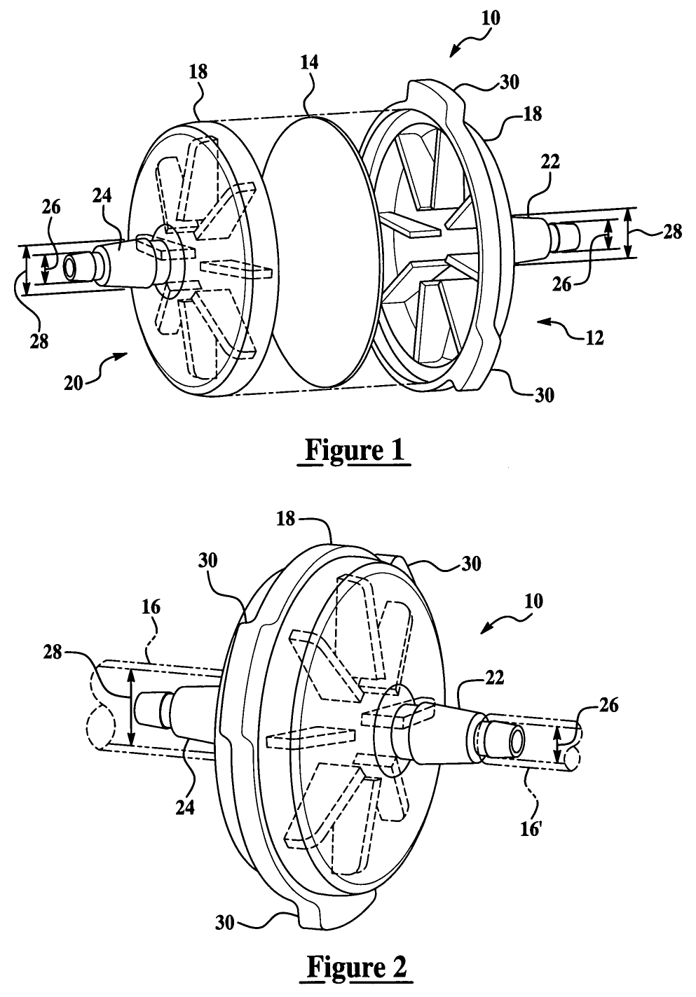

Referring now to FIGS. 1 and 2 together, an embodiment of a filter assembly 10 having a filter media 14 therein is shown. The filter assembly 10 may be used with one or more tubes 16, having various sizes. The filter assembly 10 may include a filter housing 18 adapted to contain the filter media 14 therein. It is to be understood that the filter media 14 may be disposed entirely within the filter housing 18, partially within the filter housing 18, or may be operatively engaged with the filter housing 18.

The filter media 14 may be of any suitable form and/or adapted for any suitable use. As such, the filter media 14 may be embodied in any suitable shape and/or may be formed from any suitable material. As non-limitative examples, the filter media 14 may be formed from a HEPA material, may be suitable for bacterial filtration (e.g., is formed from a bacterial filtration material, as discussed in, for example, document number BS EN 13544-3 (“Respiratory Therapy Equipment—Part 3: Air Entrainment Devices”, from British Standards Institution, published on Jul. 15, 2001), and/or may be a loose fiber filtration material. The filter media 14 may also be stamped into a non-pleated disk, a pleated disk, or combinations thereof. As a non-limitative example, the filter media 14 may be suitable for use with an oxygen delivery system.

The filter assembly 10 is also shown as having a front 12 and a back 20. It is to be understood that the terms “front” and “back” are not intended to be limited to, nor necessarily meant to convey a spatial orientation, but rather are used for illustrative purposes to differentiate two opposed ends in any spatial orientation (top, bottom, side, angularly offset, and/or the like). However, it is to be understood that in fabrication situations, “front” and “back” may signify a specific spatial orientation.

It is to be understood that the filter housing 18 may be formed of any suitable material. Non-limitative examples of such materials include polypropylenes, polyethylenes, polycarbonates, polyesters, styrene butadiene copolymers, acetal resins (a non-limitative example of which includes DELRIN, which is commercially available from Dupont, located in Wilmington, Del.), or the like, or combinations thereof.

In an embodiment, the filter housing 18 has a first nipple 22 and a second nipple 24. At least one of the first nipple 22 or the second nipple 24 is adapted to engage with the tube 16 (as shown in phantom in FIG. 2). As such, the first nipple 22 and/or the second nipple 24 may be designed for releasable engagement with a tube 16 having any suitable size, shape, and/or configuration. For example, the first and/or second nipples 22, 24 may have a diameter sufficiently smaller than that of a tube 16 so that the tube 16 may releasably engage the nipple(s) 22, 24. Engagement between the first and/or second nipple 22 and the tube 16 may be, for example, press-fit. Although nipples 22, 24 and tubes 16, 16′ are shown in the figures as having generally circular cross-sections, it is to be understood that the respective cross-sections may be any suitable regular or irregular geometric shape, as long as the respective nipples 22, 24 and tubes 16, 16′ are substantially engageable as described herein.

In another embodiment, the first nipple 22 and/or the second nipple 24 have/has a first tube-engaging outer diameter 26 and a second tube-engaging outer diameter 28. As such, it is to be understood that nipple(s) 22, 24 may have a plurality of segments whereby adjacent segments have diameters of different magnitudes. As non-limitative examples, the first outer diameter 26 or the second outer diameter 28 may be adapted for engagement with a tube 16 having an ⅛ inch inner diameter, with a tube 16 having an inner diameter substantially larger than an ⅛ inch, or with a tube 16 having an inner diameter substantially smaller than an ⅛ inch. In an embodiment, the first outer diameter 26 is adapted for engagement with an ⅛ inch inner diameter tube 16′, and the second outer diameter 28 is adapted for engagement with a tube 16 having an inner diameter substantially larger than an ⅛ inch or substantially smaller than an ⅛ inch (i.e., an inner diameter different from that of tube 16′). It is to be understood that the outermost outer diameter, which is illustrated in FIGS. 1-5 as the first outer diameter 26, may have a diameter smaller than that of the innermost outer diameter, which is illustrated as the second outer diameter 28.

In an embodiment, a nipple 22, 24 having first and second outer diameters 26, 28 may engage one or more tubes 16 having one or more standard (or any desired) inner diameter sizes. In a non-limitative example, the connections to be fitted correspond with standards referenced in document number BS EN 13544-2 (“Respiratory Therapy Equipment—Part 2: Tubing and Connectors,” from British Standards Institution, published on Oct. 31, 2002). As such, the first and second outer diameters 26, 28 may provide for engagement between the filter assembly 10 and one or more off-the-shelf (or specialty) tubes 16.

In another embodiment, and as shown in FIG. 2, each of the nipples 22, 24 may engage a different sized tube 16, 16′ (non-limitative examples of which include cannulas having different inner diameters). As a non-limitative example, the first nipple 22 may engage a first tube 16′ having a diameter that is of a size sufficient to sealingly, selectively engage the first nipple 22. As shown in FIG. 2, the tube 16′ has an inner diameter a little larger than diameter 26 so that it fits over the smaller portion of the first nipple 22. The second nipple 24 may engage a second tube 16 having an inner diameter that is of a size sufficient to sealingly, selectively engage the second nipple 24. As shown in FIG. 2, the tube 16 has an inner diameter a little smaller than diameter 28 so that it seals and fits over the larger portion of the second nipple 24.

It is to be understood that the nipples 22, 24 may have the varying diameters 26, 28. It is to be further understood that the respective diameters 26, 28 for each nipple 22, 24 may be substantially the same or different (e.g., diameter 26 for nipple 24 may be substantially the same as diameter 26 for nipple 22, etc.; or diameter 28 for nipple 24 may be different from diameter 28 for nipple 22, etc.). In an alternate embodiment, nipples 22, 24 may each have a substantially consistent diameter (e.g. a single diameter 26 or 28), as long as the single diameter 26 or 28 of each of the two nipples 22, 24 is different (e.g., nipple 22 may have a single diameter 26, and nipple 24 may have a single diameter 28, where diameter 26 is different from diameter 28, etc.).

Referring now to FIGS. 1-5 together, the filter assembly 10 may also include at least one engaging member 30 adapted to releasably engage with an engaging member 34 of a manifold 38. Examples of materials suitable for forming the manifold 38 include, but are not limited to polypropylenes, polyethylenes, polycarbonates, polyesters, styrene butadiene copolymers, acetal resins, or the like, or combinations thereof.

In an embodiment, the filter housing engaging member 30 or the manifold engaging member 34 is a tab and the other of the manifold engaging member 34 or the filter housing engaging member 30 is a cavity. It is to be understood that the cavity is configured to releasably engage with the tab. Thus, in an embodiment, a plurality of filter housing engaging members 30 enmesh with a plurality of manifold engaging members 34, and rotating the filter housing 18 anywhere from about 1° to about 180° releasably engages the filter assembly 10 with the manifold 38. It is to be understood that the filter housing engaging member(s) 30 and the manifold engaging member(s) 34 may be of any suitable shape that provides for engagement therebetween.

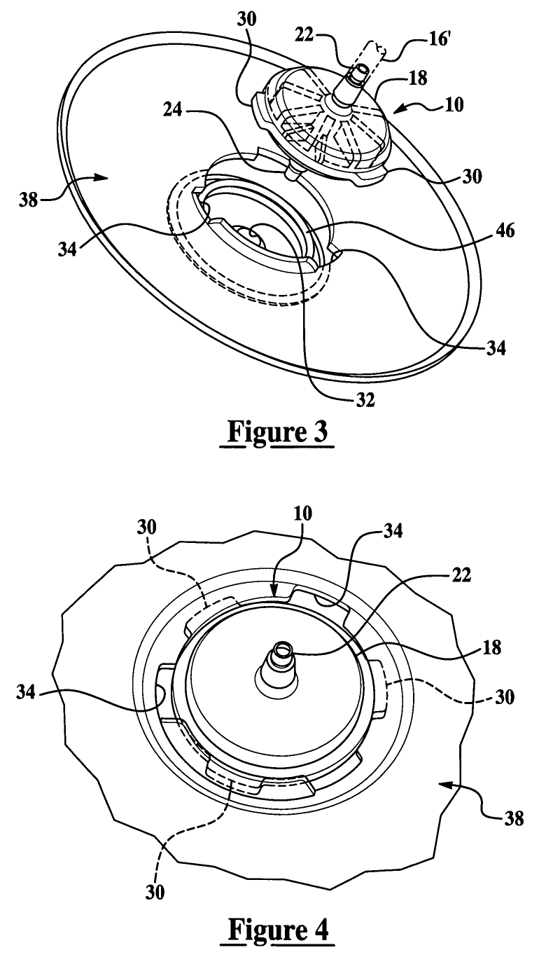

The first nipple 22 and/or the second nipple 24 may be adapted to sealingly engage with the manifold 38. As depicted in FIG. 3, the manifold 38 includes a bore 32 that is capable of releasably engaging the nipple 22, 24. Within the bore 32 is a seal member 42 that sealingly engages the inserted nipple 22, 24. Non-limitative examples of such seal members 42 include o-rings, gaskets, face seals (e.g., rubberized face seals), or the like, or various combinations thereof. It is to be understood that the seal member 42 may be adapted to engage with the first nipple 22 or the second nipple 24, whichever is inserted into the bore 32. It is to be further understood that the seal member 42 is adapted to engage with the first outer diameter 26 or the second outer diameter 28 of the first or second nipple 22, 24.

It is to be understood that, in this embodiment, if one of the first nipple 22 or the second nipple 24 engages with a tube 16, then the other of the second nipple 24 or the first nipple 22 sealingly engages with the manifold 38. As such, the filter assembly 10 may be adapted to simultaneously operatively engage a tube 16 and a manifold 38.

An embodiment of a method of releasably mounting the filter assembly 10 includes aligning the engaging member 30 of the filter housing 18 with the engaging member 34 of the manifold 38, and then contacting the aligned members. The filter housing 18 is then rotated at an angle ranging from about 1° to about 180° relative to the manifold 38.

In another embodiment, the engaging member 30 and the manifold engaging member 34 are releasably engaged via a rotation of the filter housing 18 ranging from about 30° to about 60° with respect to the manifold 38.

In yet another embodiment, the engaging members 30, 34 are releasably engaged via a filter housing 18 rotation of about 45° with respect to the manifold 38. As such, it is to be understood that, in this embodiment, the rotation of the filter housing 18 may be referred to as a “quarter turn” and/or the releasable engagement between the filter assembly 10 and the manifold 38 may be referred to as a “quarter turn interlock.”

As the filter assembly 10 is adapted for use with a tube 16, the method also includes engaging the tube 16 with whichever of the first and second nipples 22, 24 is not engaged with the manifold 38. Alternately, the filter assembly 10 may be adapted for use with two tubes 16, 16′. As such, the method includes engaging one tube 16, 16′ with one of the nipples 22, 24, and engaging the other tube 16′, 16 with the other of the nipples 24, 22 (as shown in FIG. 2).

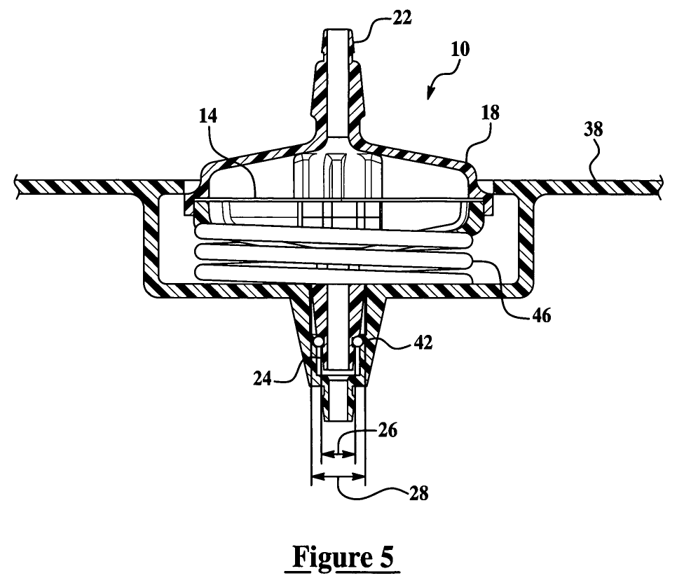

The filter assembly 10 may also include a spring 46 (shown in FIG. 5) operatively disposed between the manifold 38 and the filter housing 18. The spring 46 may bias the filter housing 18 away from the manifold 38 upon reverse rotation of the filter housing 18. As such, in an embodiment of a method for releasably mounting the filter assembly 10, rotating the filter housing 18 may include resisting the spring 46 operatively disposed between the manifold 38 and the filter housing 18. The method may also include reversing the initial rotation of the filter housing 18 so that the spring 46 biases the filter housing 18 away from the manifold 38, thereby releasing the engagement of the two 18, 38.

While several embodiments have been described in detail, it will be apparent to those skilled in the art that the disclosed embodiments may be modified. Therefore, the foregoing description is to be considered exemplary rather than limiting.

What is claimed is:

1. A filter assembly having a filter media, the filter assembly adapted for use with a tube, the filter assembly comprising:
a filter housing adapted to contain the filter media therein, the filter housing including:
a first nipple;
a second nipple, wherein at least one of the first or second nipples is adapted to engage with the tube; and
at least one engaging member adapted to releasably engage with an engaging member of a manifold via a rotation of the filter housing from about 1° to about 180°.

2. The filter assembly of claim 1 wherein one of the engaging member or the manifold engaging member is a tab, and the other of the manifold engaging member or the engaging member is a cavity adapted to releasably engage with the tab.

3. The filter assembly of claim 1 wherein the other of the second nipple or the first nipple is adapted to sealingly engage with the manifold.

4. The filter assembly of claim 1 wherein the at least one of the first nipple or the second nipple has a first, tube-engaging outer diameter and a second, tube-engaging outer diameter.

5. The filter assembly of claim 4 wherein the first diameter is adapted for engagement with an ⅛ inch inner diameter tube.

6. The filter assembly of claim 5 wherein the second diameter is adapted for engagement with a tube having an inner diameter substantially larger than ⅛ inch or substantially smaller than ⅛ inch.

7. The filter assembly of claim 1 wherein the engaging member and the manifold engaging member releasably engage via a rotation of the filter housing from about 30° to about 60°.

8. The filter assembly of claim 7 wherein the filter assembly is sealingly engaged with the manifold via a sealing member selected from o-rings, gaskets, face seals, or combinations thereof.

9. The filter assembly of claim 1 wherein the filter media is formed from a material selected from a HEPA material and a bacterial filtration material.

10. The filter assembly of claim 1 wherein the filter media is stamped into a non-pleated disk, a pleated disk, or combinations thereof.

11. The filter assembly of claim 1 wherein the filter media is adapted for bacterial filtration.

12. The filter assembly of claim 1 wherein the filter assembly is adapted for use with an oxygen delivery system.

13. The filter assembly of claim 1, further comprising a spring operatively disposed between the manifold and the filter housing, the spring biasing the filter housing away from the manifold upon reverse rotation of the filter housing.

14. A method for releasably mounting a filter assembly adapted for use with a tube, the method comprising:
aligning an engaging member of a filter housing with an engaging member of a manifold, the filter housing having a first nipple and a second nipple, each of the first and second nipples having at least two differently sized tube-engaging outer surfaces;
contacting the aligned filter housing engaging member and the manifold engaging member;
engaging the tube with at least one of the first nipple or the second nipple; and
rotating the filter housing from about 1° to about 180° relative to the manifold, thereby releasably engaging the filter housing engaging member with the manifold engaging member.

15. The method of claim 14 wherein one of the engaging member or the manifold engaging member is a tab, and the other of the manifold engaging member or the engaging member is a cavity adapted to engage with the tab.

16. The method of claim 14 wherein rotating the filter housing further comprises resisting a spring operatively disposed between the manifold and the filter housing.

17. The method of claim 16, further comprising reversing the rotation of the filter housing, whereby the spring biases the filter housing away from the manifold.

18. The method of claim 14 wherein the filter housing is rotated from about 30° to about 60° relative to the manifold.

19. The method of claim 14 wherein the tube is engaged with one of the first nipple or the second nipple, and the method further comprises engaging an other of the second nipple or the first nipple with a seal member disposed in the manifold.

20. A method for using a filter assembly having two opposed nipples, comprising:
engaging a first nipple located at a front of a filter housing with a first tube having a first diameter of a size sufficient to sealingly engage the first nipple; and
engaging a second nipple located at a back of the filter housing with a second tube having a second diameter of a size sufficient to sealingly engage the second nipple, the first diameter being different than the second diameter.
